(19) United States
(12) Patent Application Publication
(10) Pub. No.: US 2002/0104705 A1
(43) Pub. Date: Aug. 8, 2002

(54) Steering wheel assembly with integrated brake and throttle controls

(76) Inventor: Robert M. Kuhn JR., Lambertville, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 09/776,607

(22) Filed: Feb. 2, 2001

(51) Int. Cl. B60K 26/00

(52) U.S. Cl. 180/333

(57) ABSTRACT

A steering wheel assembly for an automobile having integrated brake and throttle controls, said assembly comprising a steering wheel having a rim and a first twist grip having longitudinal axis and a second twist grip having a longitudinal axis, said first twist grip and said second twist grip being integral with said rim of steering wheel, wherein rotation of said first twist grip around its longitudinal axis operates said brake, and rotation of said second twist grip around its longitudinal axis operate said throttle.

### FIELD OF THE INVENTION

The present invention relates generally to a steering wheel assembly for an automobile, and more particularly, to a steering wheel assembly having integrated brake and throttle controls.

### BACKGROUND

While the background of this invention discussed below is in the context of a steering wheel assembly having integrated brake and throttle controls, those of ordinary skill in the art will appreciate that the present invention has application beyond that. Specifically, this invention would, among other things, alleviate many of the problems and difficulties commonly associated with the operation of automobiles by physically challenged people.

As our society has grown increasingly mobile, our dependence on the automobile has also increased. Modern lifestyles require ready access to automobiles for all people, and the personal freedoms they allow.

Generally, automobiles are provided with an accelerator foot pedal for controlling the speed of a vehicle, and a brake foot pedal for slowing down or stopping the vehicle. The accelerator and brake are conventionally operated by foot.

In some instances, a cruise control device that maintains a constant road speed is used to augment speed control. When activated, the device controls the throttle in such a manner that it strives to maintain a constant speed at the value prevailing at the instant of operation. A cruise control device may also incorporate throttle control functions that permit the deceleration and the acceleration of the automobile. Deceleration may be achieved by the abrupt closure of the throttle, while acceleration is accomplished through the opening of the throttle.

Cruise control devices are typically located on a lever that is mounted on the automobile's steering column. More recently, the cruise control device has also been located on or integral with the steering wheel assembly. Placement of the cruise control device on or integral with the steering wheel assembly allows for quick and easy access to the automobile's speed control without diverting the operator's attention from the road.

Others have recognized the benefit of putting an accelerator control on the steering wheel assembly. In U.S. Pat. No. 5,335,743 to Gillbrand et al (“the '743 patent), for example, a control unit is disclosed for operating both the accelerator and gear changing functions of an automobile. The control unit is mounted on a spoke of the steering wheel assembly, adjacent to the steering wheel's rim. The control unit allows the operator to manipulate the control unit with the operator's fingers while the operator's hand maintains its grip on the steering wheel. When the control unit is moved in mutually independent directions, acceleration and deceleration of the automobile may be controlled. Upward and downward movement of the control unit results in the automobile changing gears.

However, the control unit disclosed in the '734 patent requires movements that may be contrary to the natural expectations of the operator. As such, learning the movements required to accelerate or decelerate an automobile so that they become second nature may present significant difficulties. The counterintuitive method of controlling the acceleration and gear changing functions of an automobile with a control unit as disclosed in the '734 patent would be especially problematic in emergency situations.

This invention, on the other hand, is directed to a steering wheel assembly that has a first twist grip and a second twist grip. The first and second twist grips are integral with the steering wheel assembly's rim. By rotating the first and second twist grips around their longitudinal axes, the automobile's acceleration and braking may be controlled.

There are, of course, numerous ways in which the first and second twist grips could actuate the automobile's acceleration and braking. This would include, for example, mechanical linkages between the first and second twist grips and the automobile's throttle and brake. Alternatively, the first and second twist grips could be electronically coupled to the throttle and brake. Where the first and second twist grips are electronically coupled to the throttle and brake, the first and second twist grips would have position sensors such as a rheostat, a potentiometer, or some other rotational position sensors known in the art. And, whether the first and second twist grips are mechanically or electronically coupled to the automobile's throttle and brake, one of ordinary skill in the art will appreciate that the rotational movement of the twist grips may be directly or relatively proportional to the operational function which they control.

### SUMMARY OF THE INVENTION

In the present invention, a first twist grip having a longitudinal axis and a second twist grip having a longitudinal axis are incorporated into a steering wheel assembly to actuate an automobile's brake and throttle. The first twist grip and the second twist grip are integral with the steering wheel assembly's rim. Rotating the first twist grip around its longitudinal axis operates the automobile's brake, while rotating the second twist grip around its longitudinal axis operates the automobile's throttle.

It is therefore an object of this invention to provide a steering wheel assembly for an automobile that has integrated brake and throttle controls to improve and simplify the control functions available to all drivers, including those that are physically challenged.

Further areas of applicability of the present invention will become apparent from the detailed description provided hereinafter. It should be understood, however, that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a perspective view of an automobile with a steering wheel assembly in accordance with the present invention;

FIG. 2 is an elevation view of a steering wheel assembly in accordance with the present invention;

FIG. 3 is block diagrams of mechanical linkages in accordance with the present invention;

FIG. 4 is block diagrams of electronic linkages in accordance with the present invention;

FIG. 5 is block diagrams in accordance with one embodiment of the present invention; and

FIG. 6 is block diagrams in accordance with another embodiment of the present invention.

### DETAILED DESCRIPTION OF THE PREFERRED EMBODIMENTS

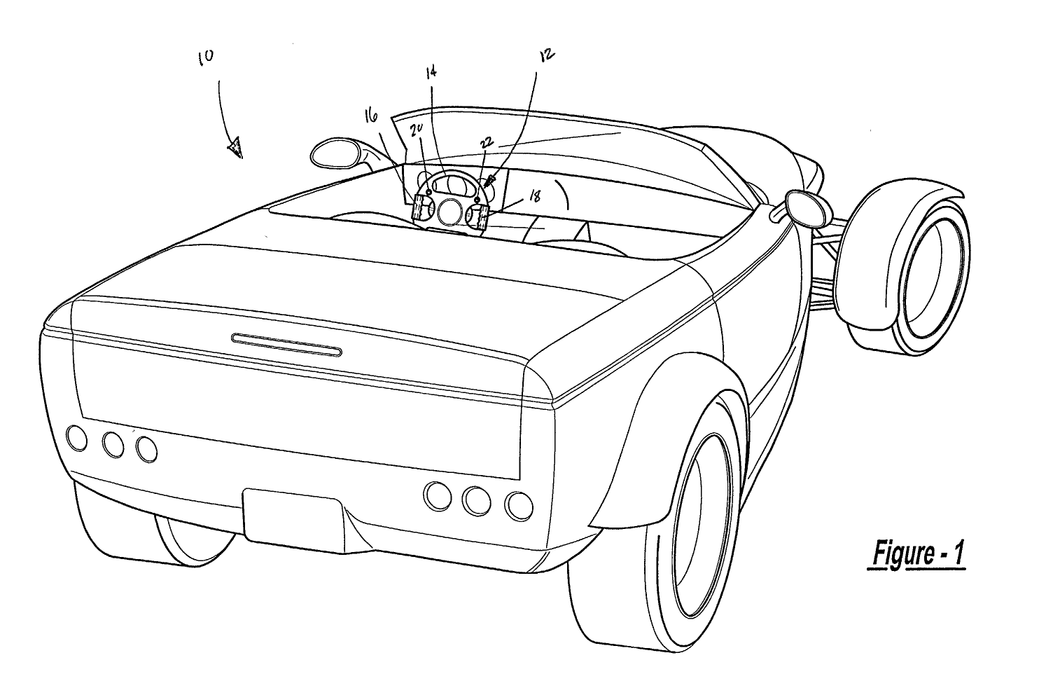

One embodiment of the steering wheel assembly with integrated brake and throttle controls is shown in FIG. 1. Automobile 10 has a steering wheel assembly 12. Steering wheel assembly 12 has a rim 14. Integral with rim 14 is first twist grip 16 and second twist grip 18. Steering wheel assembly 12 also has a first button 20 and a second button 22. First button 20 and second button 22 are in communication with a transmission gearbox (not shown) of automobile 10. By depressing first button 20 of steering wheel assembly 12, the operator may change the gears of automobile 10 downwardly. By depressing second button 22 of steering wheel assembly 12, the operator may effect an upward gear change of automobile 10.

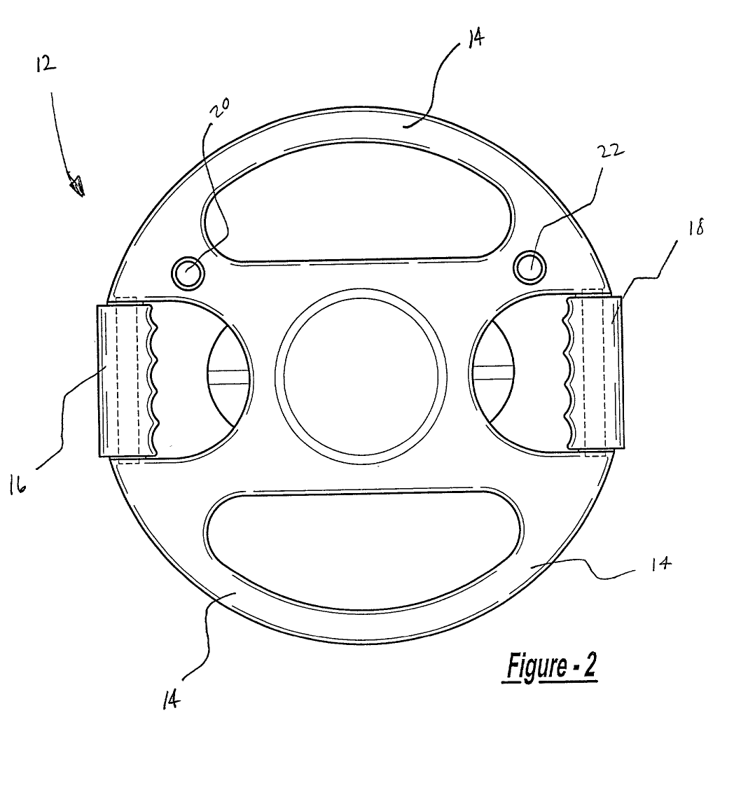

FIG. 2 is an elevation view of steering wheel assembly 12. Again, steering wheel assembly 12 has a rim 14 to which first twist grip 16 and second twist grip 18 are integrally connected. First button 20 and second button 22 are located on steering wheel assembly 12. First button 20 and second button 22 are in communication with the transmission gearbox (not shown) of automobile 10, whereby the operator, by depressing first button 20 and second button 22, effects a gear change in the transmission gearbox.

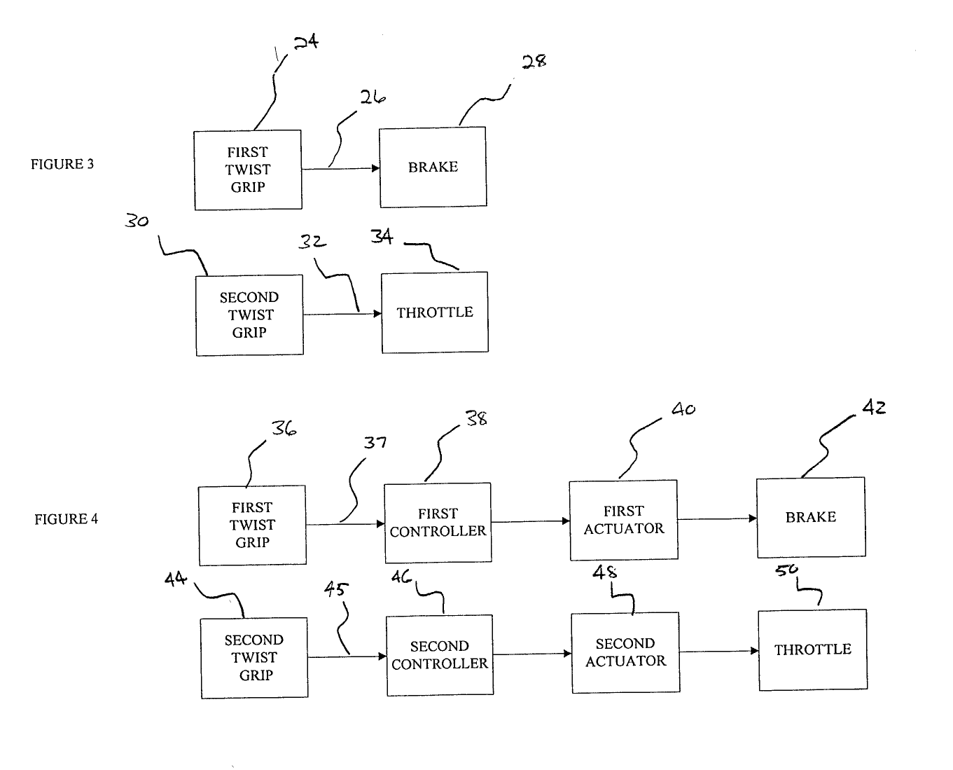

FIG. 3 is block diagrams of one embodiment of this invention. First twist grip 24 has a first mechanical linkage 26 to brake 28. By rotating first twist grip 24 around its longitudinal axis, the automobiles brake 28 is controlled through first mechanical linkage 26. On the other hand, second twist grip 30 is connected to throttle 34 through second mechanical linkage 32. Thus, by rotating second twist grip 30 around its longitudinal axis, the automobile's throttle 34 may be controlled through second mechanical linkage 32.

FIG. 4 is another embodiment in the present invention, again shown in block diagram. In FIG. 4, first twist grip 36 is electronically linked to first controller 38. When rotating first twist grip 36 around its longitudinal axis, a first control signal 37 is transmitted to first controller 38. The first controller 38 is in communication with a first actuator 40. When first controller 38 receives first control signal 37 as a result of the rotation of first twist grip 36, first controller 38 operates first actuator 40, which in turn controls the brake 42 of said automobile. Likewise, second twist grip 44 is electronically coupled to second controller 46 as shown in FIG. 4. When second twist grip 44 is rotated around its longitudinal axis, a second control signal 45 is transmitted to second controller 46. Second controller 46 is in communication with second actuator 48 to operate throttle 50 of said automobile.

Another embodiment of the present invention in shown in FIG. 5. In FIG. 5, the first twist grip is a first rheostat 52. By rotating the first twist grip around its longitudinal axis, first rheostat 52 varies a first control signal 53 in an amount proportional to the rotation of first rheostat 52. First control signal 53 is transmitted to first controller 54. First controller 54 delivers a first output 55 that is responsive to the variance of first control signal 53. In turn, first actuator 56, which is in communication with first controller 54 and is responsive to variation in first output 55, operates brake 58 in a manner commensurate with the variation of first output 55.

Similarly, FIG. 5 also shows a second twist grip that comprises a second rheostat 60. By rotating the second twist grip around its longitudinal axis, second rheostat 60 varies a second control signal 61 in an amount proportional to the rotation of second rheostat 60. Second control signal 61 is transmitted to second controller 62. Second controller 62 delivers a second output 63 that is responsive to the variance of second control signal 61. Second actuator 64, which is in communication with second controller 62 and is responsive to variation in second output 63, operates throttle 66 in a manner commensurate with the variation of second output 63.

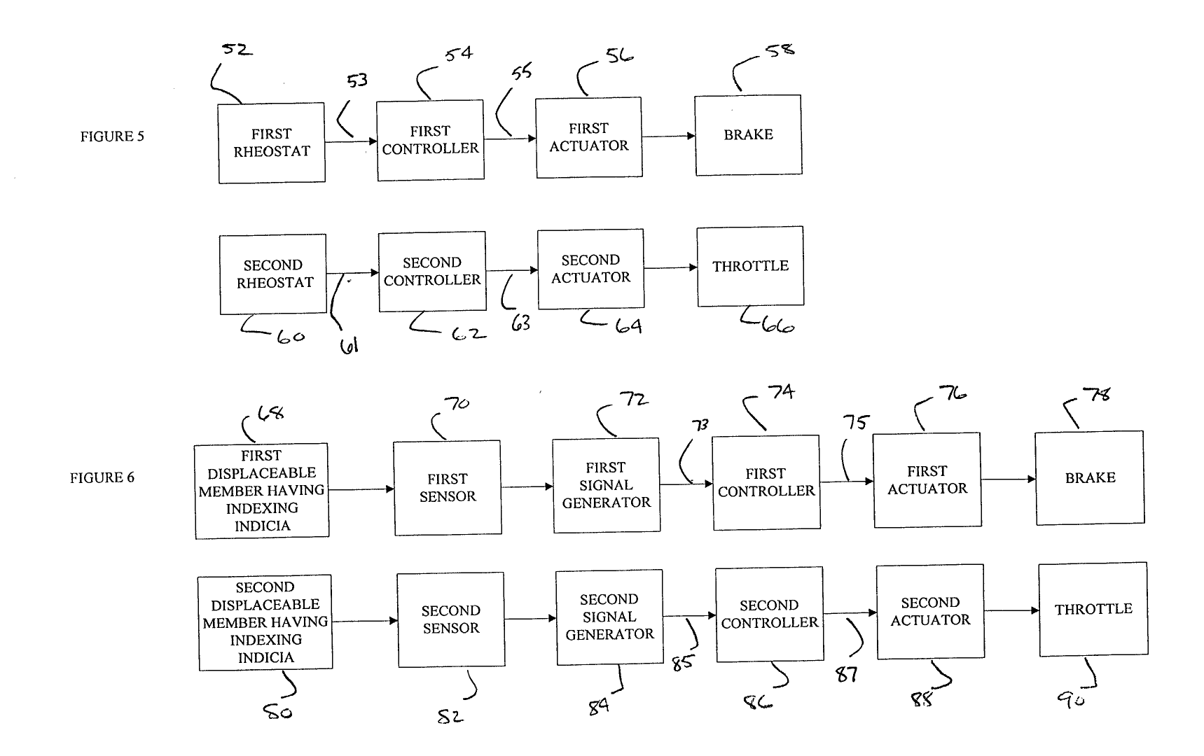

FIG. 6 provides another embodiment of the present invention. In FIG. 6, first twist grip is a first displaceable member having indexing indicia 68 as detected by first sensor 70. First displaceable member having indexing indicia 68 is in communication with first sensor 70 and first signal generator 72. First sensor 70 detects the physical position of first displaceable member having indexing indicia 68. First signal generator 72 then generates a first control signal 73 that varies according to the physical position of first displaceable member having indexing indicia 68. In response to first control signal 73, first controller 74 delivers a first output 75 that is responsive to the variance of first control signal 73. In turn, first actuator 76, which is in communication with first controller 74 and is responsive to variations in first output 75, operates brake 78 in a manner commensurate with the variation of first output 75.

Also shown in FIG. 6 is a second displaceable member having indexing indicia 80 in communication with second sensor 82 and second signal generator 84. Second sensor 82 detects the physical position of second displaceable member having indexing indicia 80. Second signal generator 84 then generates a second control signal 85 that varies according to the physical position of second displaceable member having indexing indicia 80 as detected by second sensor 82. In response to second control signal 85, second controller 86 delivers a second output 87 that is responsive to the variance of second control signal 85. In turn, second actuator 88, which is in communication with second controller 86 and is responsive to variations in second output 87, operates throttle 90 in a manner commensurate with the variation of second output 87.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. A steering wheel assembly for an automobile having integrated brake and throttle controls, said assembly comprising:
a steering wheel having a rim; and
a first twist grip having a longitudinal axis and a second twist grip having a longitudinal axis, said first twist grip and said second twist grip being integral with said rim of said steering wheel, wherein rotation of said first twist grip around its longitudinal axis operates said brake, and rotation of said second twist grip around its longitudinal axis operates said throttle.

2. The steering wheel assembly according to claim 1 wherein said first twist grip is electrically coupled to said brake control so that rotating said first twist grip around its longitudinal axis causes a first control signal to be transmitted to a first controller, said first controller being in communication with a first actuator, and said first actuator controlling braking of said automobile.

3. The steering wheel assembly according to claim 2 wherein said first twist grip is a first rheostat so that rotation of said first twist grip around its longitudinal axis varies said first control signal in accordance with the rotation of said first twist grip.

4. The steering wheel assembly according to claim 3 wherein said first controller's output varies according to said first control signal, and said first actuator is responsive to said first controller's variable output.

5. The steering wheel assembly according to claim 2 wherein said first twist grip comprises a first displaceable member having indexing indicia, a first sensor for detecting a physical position of said indexing indicia, and a first signal generator in communication with said first sensor for generating said first control signal in accordance with said physical position of said indexing indicia, so that the rotation of said first twist grip around its longitudinal axis causes said first control signal generated by said first signal generator to vary according to said physical position of said indexing indicia.

6. The steering wheel assembly according to claim 5 wherein said first controller's output varies according to said first control signal, and said first actuator is responsive to said first controller's variable output.

7. The steering wheel system according to claim 2 wherein said second twist grip is electrically coupled to said throttle control so that rotation of said second twist grip around its longitudinal axis causes a second control signal to be transmitted to a second controller, said second controller being in communication with a second actuator, and said second actuator controlling said throttle of said automobile.

8. The steering wheel assembly according to claim 7 wherein said second twist grip is a second rheostat so that rotation of said second twist grip around its longitudinal axis varies said second control signal in accordance with said rotation of said second twist grip.

9. The steering wheel assembly according to claim 8 wherein said second controller's output varies according to said second control signal, and said second actuator is responsive to said second controller's variable output.

10. The steering wheel assembly according to claim 7 wherein said second twist grip comprises a second displaceable member having indexing indicia, a second sensor for detecting a physical position of said indexing indicia, and a second signal generator in communication with said second sensor for generating said second control signal in accordance with said physical position of said indexing indicia, so that rotation of said second twist grip around its longitudinal axis causes said second control signal generated by said second signal generator to vary according to said physical position of said indexing indicia.

11. The steering wheel assembly according to claim 9 wherein said second controller's output varies according to said second control signal, and said second actuator is responsive to said second controller's variable output.

12. The steering wheel assembly according to claim 1 wherein mounted on said steering wheel assembly is at least one button in communication with said automobile's transmission gearbox such that by depressing said at least one button, said transmission gearbox changes gears.

13. The steering wheel assembly according to claim 1 wherein said first twist grip of said automobile and said second twist grip of said automobile can be selectively disabled.

14. A steering wheel assembly for an automobile having integrated brake and throttle controls, said steering wheel assembly comprising:
a steering wheel having a rim;
a first twist grip having a longitudinal axis, said first twist grip being integral with said rim of said steering wheel, said first twist grip being electrically coupled to said brake control so that rotating said first twist grip around its longitudinal axis causes a first control signal to be transmitted to a first controller, said first controller being in communication with a first actuator, and said first actuator controlling braking of said automobile; and
a second twist grip having a longitudinal axis, said second twist grip being integral with said rim of said steering wheel, and said second twist grip being electrically coupled to said throttle control so that rotating said second twist grip around its longitudinal axis causes a second control signal to be transmitted to a second controller, said second controller being in communication with a second actuator, and said second actuator controlling said throttle of said automobile.

15. The steering wheel assembly according to claim 14 wherein said first twist grip is a first rheostat so that rotation of said first twist grip around its longitudinal axis varies said first control signal in accordance with the rotation of said first twist grip, said first controller's output varies according to said first control signal, and said first actuator is responsive to said first controller's variable output.

16. The steering wheel assembly according to claim 14 wherein said first twist grip comprises a first displaceable member having indexing indicia, a first sensor for detecting a physical position of said indexing indicia, and a first signal generator in communication with said first sensor for generating said first control signal in accordance with said physical position of said indexing indicia, so that the rotation of said first twist grip around its longitudinal axis causes said first control signal generated by said first signal generator to vary according to said physical position of said indexing indicia, said first controller's output varies according to said first control signal, and said first actuator is responsive to said first controller's variable output.

17. The steering wheel assembly according to claim 14 wherein said second twist grip is a second rheostat so that rotation of said second twist grip around its longitudinal axis varies said second control signal in accordance with said rotation of said second twist grip, said second controller's output varies according to said second control signal, and said second actuator is responsive to said second controller's variable output.

18. The steering wheel assembly according to claim 14 wherein said second twist grip comprises a second displaceable member having indexing indicia, a second sensor for detecting a physical position of said indexing indicia, and a second signal generator in communication with said second sensor for generating said second control signal in accordance with said physical position of said indexing indicia, so that rotation of said second twist grip around its longitudinal axis causes said second control signal generated by said second signal generator to vary according to said physical position of said indexing indicia, said second controller's output varies according to said second control signal, and said second actuator is responsive to said second controller's variable output.

19. The steering wheel assembly according to claim 14 wherein mounted on said steering wheel assembly is at least one button in communication with said automobile's transmission gearbox such that by depressing said at least one button, said transmission gearbox changes gears.

20. The steering wheel assembly according to claim 14 wherein said first twist grip of said automobile and said second twist grip of said automobile can be disabled.

21. A steering wheel assembly for an automobile having integrated brake and throttle controls, said steering wheel assembly comprising:
a steering wheel having a rim;
a first twist grip having a longitudinal axis, said first twist grip being integral with said rim of said steering wheel, said first twist grip being electrically coupled to said brake control so that rotating said first twist grip around its longitudinal axis causes a first control signal to be transmitted to a first controller, said first controller being in communication with a first actuator, and said first actuator controlling braking of said automobile; and
a second twist grip having a longitudinal axis, said second twist grip being integral with said rim of said steering wheel, and said second twist grip being electrically coupled to said throttle control so that rotating said second twist grip around its longitudinal axis causes a second control signal to be transmitted to a second controller, said second controller being in communication with a second actuator, and said second actuator controlling said throttle of said automobile.

22. The steering wheel assembly according to claim 21 wherein said first twist grip of said automobile and said second twist grip of said automobile can be disabled.
